(19) United States
(12) Patent Application Publication
(10) Pub. No.: US 2017/0107071 A1
(43) Pub. Date: Apr. 20, 2017

(54) SHEET DISCHARGING APPARATUS AND IMAGE FORMING APPARATUS

(71) Applicant: CANON KABUSHIKI KAISHA, Tokyo (JP)

(72) Inventor: Jun Agata, Suntou-gun (JP)

(21) Appl. No.: 15/297,936

(22) Filed: Oct. 19, 2016

(30) Foreign Application Priority Data
Oct. 20, 2015 (JP) 2015-206278

(51) Int. Cl. B65H 29/70; B65H 31/02; G03G 15/00

(52) U.S. Cl. CPC B65H 29/70; G03G 15/6529; B65H 31/02

(57) ABSTRACT

A sheet discharging apparatus configured to discharge a sheet includes a discharging portion, a contact member, and a detector. The discharging portion discharges a sheet so as to be bent in a curved shape in a width direction of the sheet, perpendicular to a discharging direction of the sheet when viewed in a sheet discharging direction. The contact member is moved by contact with the sheet discharged by the discharging portion, wherein the contact member includes a contact surface to be in contact with the sheet which is inclined along the curved shape of the sheet in the width direction of the sheet when viewed in the sheet discharging direction. The detector detects a discharging of the sheet based on the movement of the contact member.

### BACKGROUND OF THE INVENTION

Field of the Invention

The present invention relates to a sheet discharging apparatus configured to discharge sheets and an image forming apparatus including the sheet discharging apparatus, such as a printer and a copier.

Description of the Related Art

A sheet discharging apparatus having the following configuration is known as an example of an apparatus configured to discharge a sheet from the apparatus body to a sheet stacked portion while bending the sheet in a wave form for stiffening. The sheet discharging apparatus includes a first roller including a first rotation shaft and at least one roller body and a second rotation roller including a second rotation shaft and at least two roller bodies. The second rotation shaft is rotatably supported at a position away from the first rotation shaft with a predetermined distance therebetween. The roller body of the first roller is located between two roller bodies of the second roller so that the roller bodies of the first and second rollers are alternately positioned in a comb like arrangement (Japanese Patent No. 5173527). The roller bodies of the first and second rollers are each rotatably supported by the corresponding rotation shaft while the rotational center thereof is fixed. With this configuration, the sheet is bent into a wave form in accordance with the comb like arrangement of the roller bodies while being discharged from the apparatus body. This improves the strength of the sheet and enables the discharging angle of the sheet to be maintained during the discharging. Thus, the sheet is prevented from coming in contact with the sheet on the sheet stacked portion during the discharging, enabling the discharged sheet to be properly positioned on the sheet stacked portion and preventing a sheet on the sheet stacked portion from moving out of the sheet stacked portion, for example. Thus, the sheet is reliably stacked on the sheet stacked portion.

The above-described comb like roller in which roller bodies are positioned in the comb like arrangement may include a discharging detection sensor unit and a sensor for detecting a height of a stack of sheets. Japanese Patent No. 4065506 and Japanese Patent Laid-Open No. 2003-48644 each describe an image forming apparatus having the following configuration as an example of the apparatus including the discharging detection sensor unit and the sensor for detecting a sheet surface height.

The image forming apparatus described in Japanese Patent No. 4065506 includes a full stack detection flag movable about a rotary shaft located above a discharging port through which a sheet is discharged. The full stack detection flag is hanging down over the discharging port. The full stack detection flag is turnable so as to move among a first position, a third position, and a second position located between the first position and the third position. The full stack detection flag is positioned at the first position before the sheet is discharged. The full stack detection flag is positioned at the third position when the sheet moves up the full stack detection flag above the discharging portion. The full stack detection flag at the second position determines the height of a stack of sheets to determine the stacked state of the sheets. In addition, the full stack detection flag is configured such that positions of the front end of the full stack detection flag and the rear end of the sheet are not inverted in the direction of gravitational force when the full stack detection flag at the third position turns to fall toward the second and first positions after the rear end of the sheet passed through the discharging port. Specifically, the image forming apparatus includes a one-way friction pad, which delays the turn and falling of the full stack detection flag.

In addition, the image forming apparatus described in Japanese Patent Laid-Open No. 2003-48644 includes a sheet stacked portion, which receives a sheet on which an image was formed, and a full stack detection flag configured to determine the height of a stack of sheets on the sheet stacked portion. The full stack detection flag includes a plurality of detection levers arranged in a width direction perpendicular to a sheet discharging direction. A detection lever in contact with a lateral end of the sheet detects the height of a stack of sheets at a lower position than a detection lever in contact with a middle portion of the sheet.

The full stack detection flag and the detection lever as sensor flags, which are described in Japanese Patent No. 4065506 and Japanese Patent Laid-Open No. 2003-48644, are each flat at a portion in contact with the sheet when viewed in a cross-sectional view taken along a plane perpendicular to the rotary shaft of the sensor flag.

In the sheet discharging apparatus described in Japanese Patent No. 4065506 and Japanese Patent Laid-Open No. 2003-48644, a contact member of a detection unit, which is configured to detect the sheet discharged from the sheet discharging apparatus while being bent in the wave form for stiffening, does not uniformly come in contact with the sheet in the wave form. Thus, a load tends to concentrate on a portion of the detection unit in contact with the sheet. In particular, in the apparatus described in Japanese Patent No. 4065506 including a plurality of contact flags across the width of the sheet, a load, concentrates on one or more of the contact flags at the end in the width of the sheet, and local wear may occur at the contact flag (s). The apparatus described in Japanese Patent Laid-Open No. 2003-48644 has the same problem. In addition, various kinds of sheets passed through the sheet discharging apparatus may unevenly wear the contact flags, resulting in abnormal wear, which forms a V-shaped notch or a step.

The abnormal wear may cause a sheet, particularly a thin sheet having a low basis weight to be damaged at the discharging port or to be jammed (paper jam) due to oblique movement, resulting in improper stacked. To solve the problems, the detection unit may be formed of a material having high wearing resistance or a high polymer sheet having lower friction coefficient may be attached to the detection unit. However, this leads to an increase in the cost of the apparatus.

### SUMMARY OF THE INVENTION

An aspect of the present invention provides a sheet discharging apparatus including a contact member subjected to less abnormal wear and an image forming apparatus including the sheet discharging apparatus.

According to an aspect of the present invention, a sheet discharging apparatus configured to discharge a sheet includes a discharging portion configured to discharge a sheet so as to be bent in a curved shape in a width direction of the sheet, perpendicular to a discharging direction of the sheet when viewed in a sheet discharging direction, a contact member configured to be moved, by contact with the sheet discharged by the discharging portion, wherein the contact member includes a contact surface to be in contact with the sheet which is inclined along the curved shape of the sheet in the width direction of the sheet when viewed in the sheet discharging direction, and a detector configured to detect a discharging of the sheet based on the movement of the contact member.

Further features of the present invention will become apparent from the following description of exemplary embodiments with reference to the attached drawings.

### BRIEF DESCRIPTION OF THE DRAWINGS

FIG. 1 is a schematic cross-sectional view illustrating an image forming apparatus according to a first embodiment of the present invention.

FIG. 2 is a perspective view illustrating a sheet discharging portion according to the first embodiment.

FIG. 3A is a view illustrating an overall configuration of the sheet discharging portion viewed in a direction indicated by die arrow IIIA in FIG. 2. FIG. 3B is a magnified view of a portion encircled in FIG. 3A.

FIG. 4A is a motion diagram indicating a standby state before a sheet arrives at the sheet discharging portion. FIG. 4B is a motion diagram indicating a state in which the sheet discharged by a pair of discharging rollers arrives at a discharging detection sensor unit. FIG. 4C is a motion diagram indicating a state in which a contact flag of the discharging detection sensor unit starts rotating.

FIG. 4D is a motion diagram indicating a state in which a rear end of the sheet is discharged from the apparatus by the pair of discharging rollers. FIG. 4E is a motion diagram indicating a state in which sheets on a sheet stacked portion prevents the discharging detection sensor unit from returning to a standby state.

FIG. 5 is a perspective view illustrating a sheet discharging portion according to a second embodiment of the present invention.

FIG. 6A is a detailed view of the discharging detection sensor unit. FIG. 6B is an enlarged cross-sectional view taken along line VIB-VIB in FIG. 6A and viewed in a direction indicated by arrows.

FIG. 7 is a perspective view illustrating a sheet discharging portion according to a third embodiment of the present invention.

FIG. 8 is a magnified view of a portion in FIG. 7.

FIG. 9 is a perspective view illustrating a sheet discharging portion according to a fourth embodiment of the present invention.

FIG. 10 is a magnified view of a portion in FIG. 9.

### DESCRIPTION OF THE EMBODIMENTS

### First Embodiment

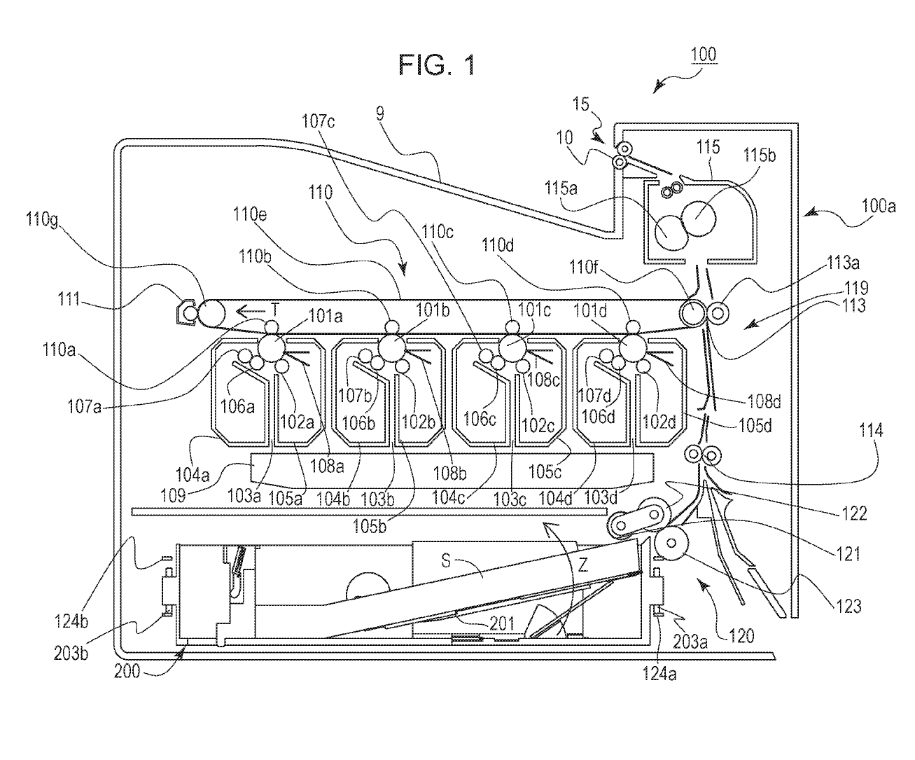

Hereinafter, a sheet discharging apparatus and an image forming apparatus according to an embodiment of the present invention are described with reference to the drawings. An image forming apparatus 100 according to the present embodiment may be a copier using an electrophotography process or an electrostatic recording process, a facsimile, a printer, or a multifunction apparatus including functions of a copier, a facsimile, and a printer, for example. The image forming apparatus 100 includes a sheet discharging apparatus configured to discharge sheets onto a sheet stacked portion. FIG. 1 is a schematic cross-sectional view illustrating the image forming apparatus 100 according to a first embodiment.

### Image Forming Apparatus

As illustrated in FIG. 1, the image forming apparatus 100 includes an apparatus body 100a. Process cartridges 103a, 103b, 103c, and 103d are detachably attached to the apparatus body 100a. The process cartridges 103a to 103d have the identical configuration, but have toners of different colors, i.e., yellow (Y), magenta (M), cyan (C), and black (Bk), for forming an image.

The process cartridges 103a to 103d include developing units 104a, 104b, 104c, and 104d, respectively, and cleaner units 105a, 105b, 105c, and 105d, respectively. The developing units 104a to 104d include developer rollers 106a, 106b, 106c, and 106d, respectively, developing material application rollers 107a, 107b, 107c, and 107d, respectively, and toner containers. The cleaner units 105a to 105d include photosensitive drums 101a, 101b, 101c, and 101d, respectively, and charging rollers 102a, 102b, 102c, and 102d, respectively. The cleaner units 105a to 105d further include drum cleaning blades 108a, 108b, 108c, and 108d, respectively, and residual toner containers.

A scanner unit 109 is disposed below the process cartridges 103a to 103d. The scanner unit 109 is configured to expose the photosensitive drums 101a to 101d to light based on image signals. The photosensitive drums 101a to 101d are negatively charged by the charging rollers 102a to 102d to predetermined potentials. Then, the scanner unit 109 forms electrostatic latent images on the photosensitive drums 101a to 101d. The electrostatic latent images are reversely developed by the developing units 104a to 104d and negatively charged toner is attached to the electrostatic latent images, and thus toner images in colors of Y, M, C, and Bk are formed on the photosensitive drums 101a to 101d.

An intermediate transfer belt unit 110 includes a drive roller 110f, a tension roller 110g, and an intermediate transfer belt 110e wound around the drive roller 110f and the tension roller 110g in a tensioned state. The tension roller 110g applies tension to the intermediate transfer belt 110e in a direction indicated by the arrow T. In addition, primary transfer rollers 110a, 110b, 110c, and 110d are disposed on an inner side of the intermediate transfer belt 110e so as to face the respective photosensitive drums 101a to 101d. A transfer bias is applied to the primary transfer rollers 110a to 110d by a bias applicator, which is not illustrated.

The photosensitive drums 101a to 101d are rotated in a clockwise direction in FIG. 1, and the intermediate transfer belt 110e is rotated in a counterclockwise direction. In addition, a positive bias is applied to the primary transfer rollers 110a to 110d. This enables the toner images on the photosensitive drums 101a to 101d to be primary transferred onto the intermediate transfer belt 110e in sequence from the toner image on the photosensitive drum 101a. The overlapped toner images in four colors are delivered to a secondary transfer portion 113. The process cartridges 103a to 103d, the intermediate transfer belt unit 110, and the secondary transfer portion 113, for example, constitute an image forming unit 119 configured to form an image on a sheet S delivered to the image forming unit 119.

After the toner image is transferred to the intermediate transfer belt 110e, the residual toner on the photosensitive drums 101a to 101d is removed by the drum cleaning blades 108a to 108d and collected in the residual toner containers. The residual toner on the intermediate transfer belt 110e after the secondary transfer to the sheet S is removed by a transfer belt cleaning unit 111. The removed toner is sent to a residual toner collecting container not illustrated), which is disposed on a rear side of the apparatus, through a residual toner path (not illustrated).

A sheet feeding portion 120 includes a feeding roller 121, a feed roller 122, and a retard roller 123, which are mounted in the apparatus body 100a, and a paper cassette 200, which is detachably mounted in the apparatus body 100a. The sheet S fed one by one from the sheet feeding portion. 120 is delivered to a pair of registration rollers 114. The paper cassette 200 is detachable in a direction toward the front in FIG. 1 (front side of the image forming apparatus 100 adjacent to the operator), i.e., in a width direction, which is perpendicular to a delivery direction of the sheet S.

The sheet S is delivered to the secondary transfer portion 113 by the pair of registration rollers 114. At the secondary transfer portion 113, a positive bias is applied to a secondary transfer roller 113a. This enables the toner images in four colors on the intermediate transfer belt 110e to be secondary transferred onto the sheet S arrived at the secondary transfer portion 113. The sheet S having the transferred toner images are delivered to a fixing unit. 115 and heated under pressure by a fixing roller 115a and a pressure roller 115b, and thus the toner images are fixed on the surface of the sheet S. The sheet C is delivered to a pair of discharging rollers 10 of a sheet discharging portion 15 and discharged onto the sheet stacked portion 9, which is a stacked portion.

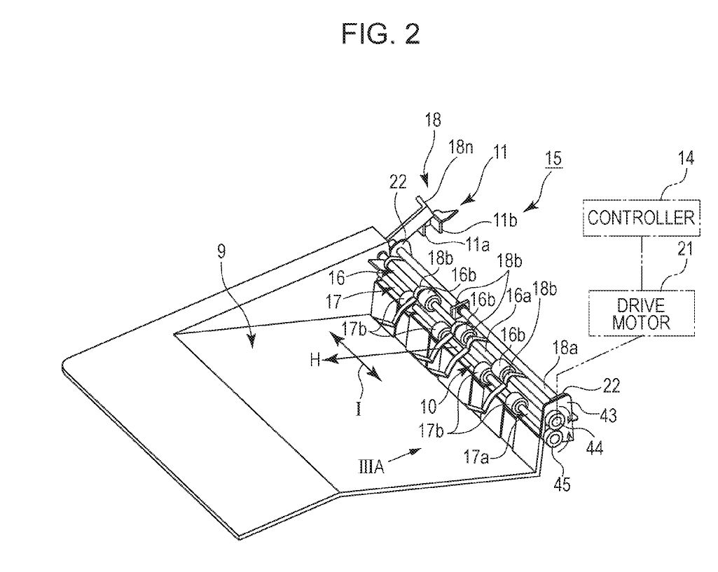

The pair of discharging rollers 10 constitutes an discharging portion configured to discharge a sheet S from the apparatus body 100a while bending the sheet S in a wave form in the width direction (indicated by the arrow I in FIG. 2), which is perpendicular to a sheet discharging direction (indicated by the arrow H in FIG. 2) for stiffening. The sheet stacked portion 9 is a stacked portion on which the sheet S discharged by the pair of discharging rollers (discharging portion) 10 is stacked. The sheet discharging portion 15 constitutes a sheet discharging apparatus configured to discharge a sheet after an image is formed on the sheet by the image forming unit 119.

### Sheet Discharging Portion

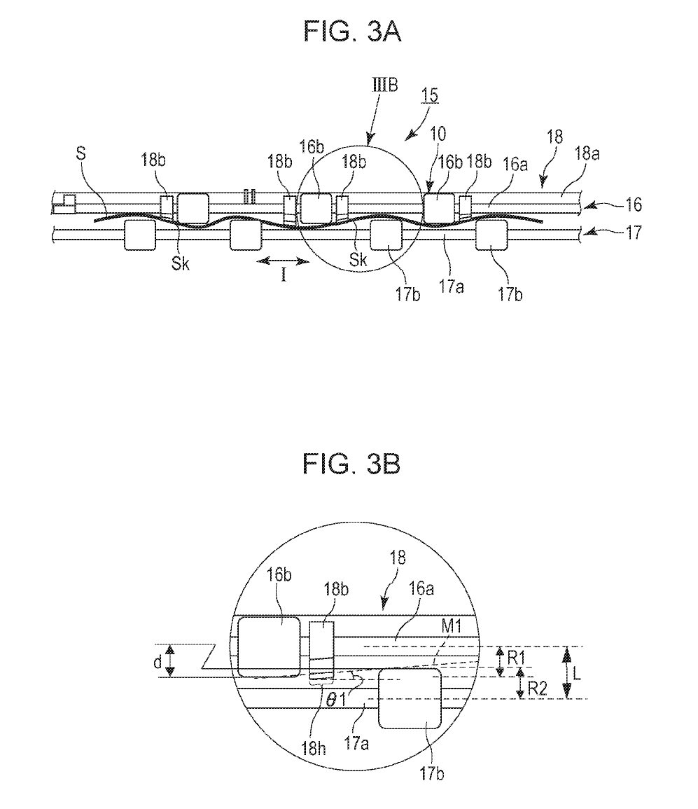

Next, the sheet discharging portion 15, which is the sheet discharging apparatus according to the present embodiment, is described in detail with reference to FIG. 2 to FIGS. 3A and 3B. FIG. 2 is a perspective view illustrating the sheet discharging portion 15 according to the present embodiment. FIG. 3A is a view illustrating the overall configuration of the sheet discharging portion 15 viewed in a direction indicated by the arrow IIIA in FIG. 2. FIG. 3B is a magnified view of a portion encircled in FIG. 3A.

The sheet discharging portion 15 includes the pair of discharging rollers (discharging portion) 10 configured to discharge a sheet from the apparatus body 100a. The sheet discharging portion 15 includes an upper discharging roller 16 and a lower discharging roller 17. An discharging detection sensor unit 18 including a plurality of contact flags (contact members) 18b configured to detect that the sheet is discharged from the apparatus by the pair of discharging rollers 10 is disposed near the pair of discharging rollers 10. The plurality of contact flags 18b are configured to determine the discharging situation of the sheet discharged by the pair of discharging rollers 10 and whether the stacked sheets on the sheet stacked portion 9 reach the stack limit.

The discharged sheet is stacked on the sheet stacked portion 9 in sequence and, when the number of the stacked sheets reaches a predetermined number, an upper surface of the uppermost sheet on the sheet stacked portion 9 sways the contact flag 18b of the discharging detection sensor unit 18. In this case, the discharging detection sensor unit 18 functions as a limit detector, which determines whether the stacked sheets on the sheet stacked portion reach the stack limit. The upper discharging roller 16 and the lower discharging roller 17 are each rotatably attached to a transportation guide 43 by a bearing, which is not illustrated.

A rotational force generated by a drive motor (drive source) 21, which is controlled by a controller 14, is transferred to the upper discharging roller 16 as a rotational force for discharging the sheet S onto the sheet stacked portion 9. The rotational force transferred to the upper discharging roller 16 is transferred to the lower discharging roller 17 by engagement of integrally fixed gears 41 and 45. The upper discharging roller 16 and the lower discharging roller 17 of the pair of discharging rollers 10 are rotated in respective directions indicated by arrows in FIG. 2 upon reception of the rotational force transferred from the drive motor 21 during the operation of the image forming apparatus 100.

As illustrated in FIG. 2 and FIG. 3A, the upper discharging roller 16 includes a first rotation shaft 16a and a plurality of first discharging roller bodies 16b fixed to the first rotation shaft 16a. The lower discharging roller 17 includes a second rotation shaft 17a and a plurality of second discharging roller bodies 17b fixed to the second rotation shaft 17a. The first and second discharging roller bodies 16b and 17b are arranged alternately in a comb like arrangement with a predetermined distance therebetween and do not form a nip portion. In other words, the first discharging roller bodies 16b and the second discharging roller bodies 17b are arranged alternately in the width direction (indicated by the arrow I), which is perpendicular to the sheet discharging direction (indicated by the arrow H), and are arranged in the vertical direction so as to face the upper surface and the rear surface of the sheet S to be discharged by the pair of discharging rollers 10. The second discharging roller bodies 17b are disposed on an opposite side of the sheet S, which is discharged from the apparatus, from the first discharging roller bodies 16b and are positioned away from the first discharging roller bodies 16b in the direction along the rotational axis of the first discharging roller bodies 16b.

As illustrated in FIG. 3B, the pair of discharging rollers 10 includes at least one first discharging roller body 16b supported coaxially by the first rotation shaft 16a and at least one second discharging roller body 17b supported coaxially by the second rotation shaft 17a such that the first and second discharging roller bodies 16b and 17b are arranged alternately in the width direction. The first discharging roller body 16b and the second discharging roller body 17b face the front surface and the rear surface of the sheet to be discharged, respectively. The distance between the first rotation shaft 16a and the second rotation shaft 17a is defined as L, the radius of the first discharging roller body 16b is defined as R1, and the radius of the second discharging roller body 17b is defined as R2. The distance L between the first and second rotation shafts 16a and 17a satisfies L<R1+R2.

In this configuration, outer peripheral portions of the first and second discharging roller bodies 16b and 17b are overlapped by a distance d. Specifically, the outer peripheral portion of the first discharging roller body 16b and the outer peripheral portion of the second discharging roller body 17b are overlapped with each other in a direction perpendicular to both the sheet discharging direction and the axial direction of the first discharging roller body 16b. The sheet S passing through the nip portion between the pair of discharging rollers 10 is bent along the arrangement of the first and second discharging roller bodies 16b and 17b for stiffening and the sheet S in the wave form illustrated in FIG. 3A is discharged. In other words, the sheet S is discharged from the apparatus while being bent in the wave form for stiffening in the width direction (indicated by the arrow I), which is perpendicular to the sheet discharging direction (indicated by the arrow H).

### Discharging Detection Sensor Unit and Peripheral Portions

Next, configurations of the discharging detection sensor unit 18 and the peripheral portions are described in detail with reference to FIGS. 3A and 3B.

As illustrated in FIG. 3A, the discharging detection sensor unit 18 includes a discharging detection sensor unit shaft 18a rotatably supported by bearings 22 (FIG. 2) at its ends. The discharging detection sensor unit 18 includes the discharging detection sensor unit shaft 18a, which extends between supported portions supported by the respective bearings 22, the plurality of contact flags 18b, which are configured to detect passage of the sheet and determine the height of the stacked sheets, and a light blocking flag 18n integrally formed on an end of the discharging detection sensor unit shaft 18a. The contact flags (contact members) 18b are rotatably supported by the apparatus body 100a and are configured to come in contact with the sheet S discharged by the pair of discharging rollers 10. At least one contact flag 18b (four contact flags 18b in this embodiment) is disposed in the width direction (indicated by the arrow I).

In addition, a photointerrupter (detector) 11 (FIG. 2) configured to detect rotation of the discharging detection sensor unit 18 is fixed at a portion of the apparatus body 100a facing the light blocking flag 18n (FIG. 2). The light blocking flag 18n is configured to move into and out of a space between a light emitting portion 11a (FIG. 2) and a light receiving portion 11b (FIG. 2) of the photointerrupter 11 such the state of the space between the light emitting portion 11a and the light receiving portion 11b is switched between a light blocking state and a light transmission state.

In FIG. 3B, a dashed straight line M1 connects an edge of the outer periphery of the first discharging roller body 16b and that of the second discharging roller body 17b when viewed in the sheet discharging direction. The contact flag 18b includes a sheet surface detection portion. 18h. The sheet surface detection portion 18h, which is an inclined guide surface of the present embodiment, extends substantially parallel to the straight line M1. Each of the other contact flags 18b also includes the sheet surface detection portion 18h, which is the inclined guide surface.

The sheet surface detection portion 18h as the inclined guide surface of the present embodiment is inclined at an angle θ1 so as to extend along the straight line M1 connecting the adjacent ends of the outer peripheral surfaces of the first and second discharging roller bodies 16b and 17b adjacent to each other in a space between the first and second rotation shafts 16a and 17a.

In other words, the contact flag 18b includes the sheet surface detection portion 18h as the inclined guide surface inclined at the angle corresponding to the wave form of a surface Sk (FIG. 3A) of the sheet S bent in the wave form in the width direction by the pair of discharging rollers (discharging portion) 10 for stiffening. The pair of discharging rollers 10 discharges the sheet S while bending the sheet in a curved form when viewed in the sheet discharging direction. The sheet surface detection portion 18h of the contact flag 18b in contact with the sheet S is inclined in the direction along the curved surface of the sheet S. The contact flag 18b, which is rotatably supported by the apparatus body 100a through the discharging detection sensor unit shaft (base portion) 18a, includes a free end portion 18j including the sheet surface detection portion (inclined guide surface) 18h. The free end portion 18j is configured to be in contact with the sheet S discharged by the pair of discharging rollers 10.

### Operation of Sheet Discharging Portion

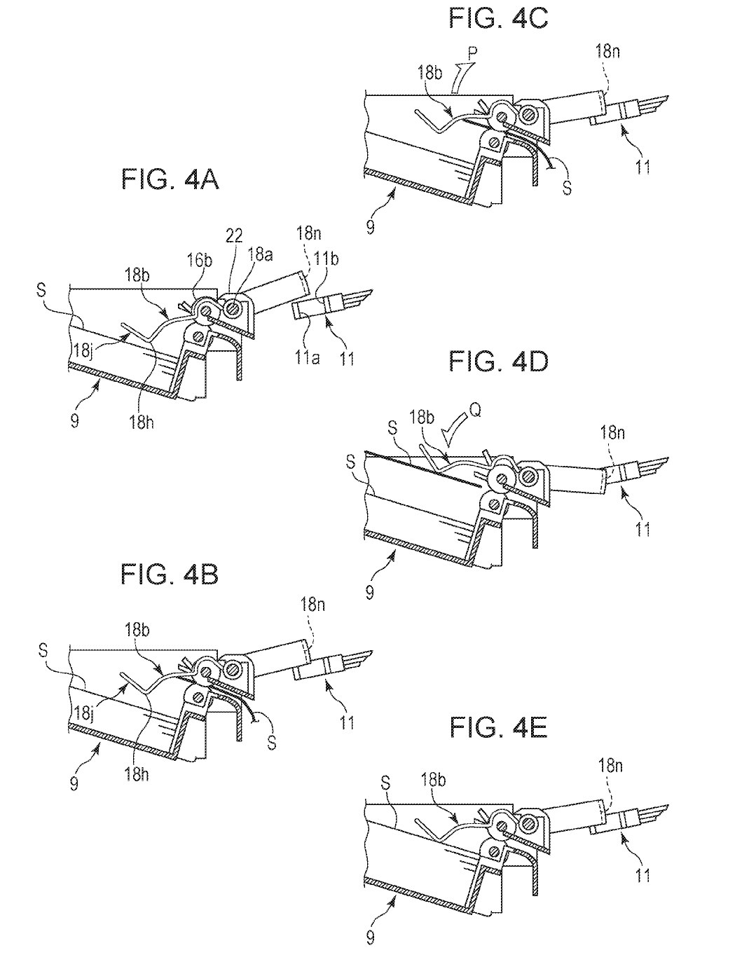

Next, the operation of the sheet discharging portion 15 is described. FIGS. 4A to 4E are motion diagrams illustrating how the sheet discharging portion 15 according to the present invention operates. FIG. 4A illustrates a standby state before a sheet arrives at the sheet discharging portion 15. FIG. 4B illustrates a state in which the sheet discharged by the pair of discharging rollers 10 arrives at the discharging detection sensor unit 18. FIG. 40 illustrates a state in which the contact flag 18b of the discharging detection sensor unit 18 starts rotating. FIG. 4D illustrates a state in which the rear end of the sheet is discharged by the pair of discharging rollers 10. FIG. 4E illustrates a state in which the sheets on the sheet stacked portion 9 prevent the discharging detection sensor unit 18 from returning to a standby state. In FIG. 4E, the sheet surface detection portion 18h in contact with an uppermost one of a stack of sheets S on the sheet stacked portion 9 extends substantially parallel to the upper surface of the stack of sheets S. The sheet surface detection portion 18h in contact with the sheet S is able to be in contact with the sheet S with almost no space.

As illustrated in FIG. 4A, when the sheet discharging portion 15 is in a standby state, the light blocking flag 18n is away from the photointerrupter 11, and the photointerrupter 11 is in the light transmission state. In the light transmission state, when the sheet S discharged by the pair of discharging rollers 10 arrives at the contact flag 18b of the discharging detection sensor unit. 18 (FIG. 4B), the front end of the sheet S comes in contacts with the sheet surface detection portion (tapered portion) 18h as the inclined guide surface.

The sheet S being discharged moves under the sheet surface detection portion 18h while being in contact with the sheet surface detection portion 18h. This turns the contact flag 18b in a direction indicated by the arrow P in FIG. 4C. Then, when the contact flag 18b is moved up by a predetermined angle, the light blocking flag 18n, which is disposed on one end of the discharging detection sensor unit shaft 18a, moves to overlap with an optical axis extending in the space between the light emitting portion 11a and the light receiving portion 11b of the photointerrupter 11, and thus the space is in the light blocking state. This enables the controller 14 to detect the passage of the sheet S.

In addition, when the rear end of the sheet C is discharged by the pair of discharging rollers 10 (FIG. 4D), the contact flag 18b starts falling in a direction indicated by the arrow Q in FIG. 4D together with the falling of the sheet A. Thus, the discharging detection sensor unit 18 is returned to the standby state indicated in FIG. 4A. If the printing further continues, as illustrated in FIG. 4E, the sheets on the sheet stacked portion. 9 prevents the contact flag 18b of the discharging detection sensor unit. 18 from returning to the standby state illustrated in FIG. 4A. Thus, the light blocking flag 18n is continuously positioned in the space between the light emitting portion 11a and the light receiving portion 11b of the photointerrupter 11, and the space is in the light blocking state.

When the controller 14 detects that the switching of the sensor state is not performed, the controller 14 determines that the sheets on the sheet stacked portion. 9 reach the stack limit. In such a case, the controller 14 stops the image forming operation. If the image forming apparatus 100 includes a status display, the controller 14 causes the status display to display that the sheets on the sheet stacked portion 9 reach the stack limit, and thus the user is informed about the status of the sheet stacked portion 9. In addition, the controller 14 informs an instruction device, which sent print instructions, that the printing is stopped because the sheets on the sheet stacked portion reached the stack limit.

In the above-described embodiment, the contact flag 18b, which is a contact portion in contact with the sheet S, includes the sheet surface detection portion (inclined guide surface) 18h to be in contact with the sheet surface (surface Sk) at an angle along the inclination of the sheet surface bent in the wave form in the width direction for stiffening. This configuration reduces a contact pressure at the sheet surface detection portion (inclined guide surface) 18h of the contact flag 18b.

In addition, the reduction in the local contact of the contact flag 18b with the sheet S reduces the local wear of the contact flag 18b. This reduces paper jam due to the local wear, leading to a longer service life of the apparatus. In addition, this reduces oblique movement of the sheet during discharging due to damage caused by the local wear, enabling the sheet to be reliably stacked onto the sheet stacked portion over all the service life of the apparatus. In addition, this reduces edge damage generated at the front end of the sheet S at the end of the service life of the contact flag 18b of the discharging detection sensor unit 18, for example.

### Second Embodiment

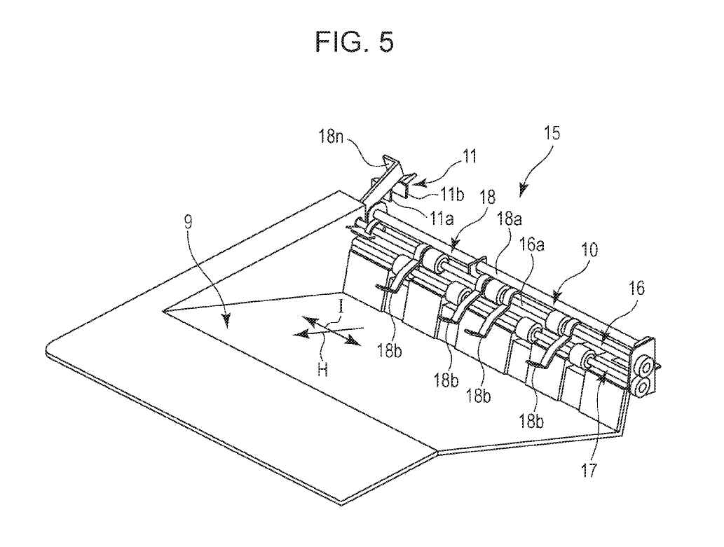

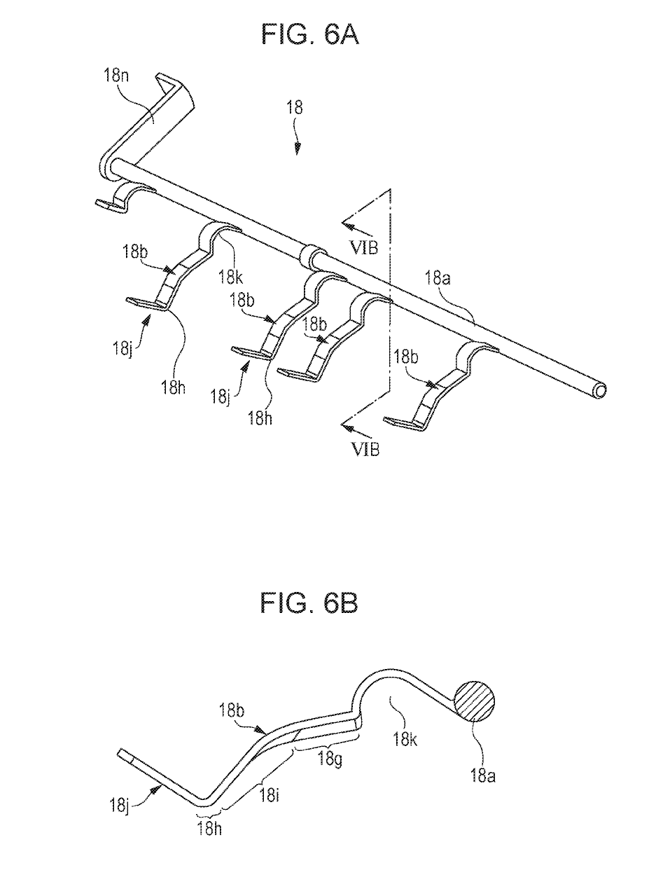

Next, a sheet discharging portion 15, which is a sheet discharging apparatus, according to a second embodiment of the present invention is described with reference to FIG. 5 and FIGS. 6A and 6B. FIG. 5 is a perspective view illustrating the sheet discharging portion 15 according to the present embodiment. FIG. 6A is a view illustrating a discharging detection sensor unit 18 in detail. FIG. 6B is a cross-sectional magnified view taken along line VIB-VIB in FIG. 6A and viewed in a direction indicated by arrows. In this embodiment, components corresponding to those in the first embodiment are assigned the same reference numerals as those in the first embodiment, and the configurations and functions thereof are not described if they are identical to those in the first embodiment.

As in the first embodiment, the sheet discharging portion 15 of the second embodiment includes a pair of discharging rollers (discharging portion) 10 including an upper discharging roller 16 and a lower discharging roller 17 configured to discharge a sheet from the apparatus body 100a. In addition, a discharging detection sensor unit 18, which is configured to detect that the sheet is discharged from the apparatus by the pair of discharging rollers 10, is disposed near the pair of discharging rollers 10. The sheet discharged from the apparatus is sequentially stacked on the sheet stacked portion 9.

FIG. 6A illustrates the discharging detection sensor unit 18 in detail. As illustrated in FIG. 6A, the discharging detection sensor unit 18 includes a discharging detection sensor unit shaft 18a rotatably supported at its each end, a plurality of contact flags 18b (four contact flags 18 in this embodiment), and a light blocking flag 18n integrally formed with the discharging detection sensor unit shaft 18a. The contact flags 18b are each fixed to the discharging detection sensor unit shaft 18a, which is a base portion, at an end opposite to a free end portion 18j. The light blocking flag 18n is configured to block the light in the photointerrupter 11, enabling the detection of the passage of the sheet. A reference numeral 18k in FIG. 6A and FIG. 6B denotes a curved portion of each contact flag 18b. The curved portion 18k of each contact flag 18b is positioned over the first rotation shaft 16a while the discharging detection sensor unit shaft 18a is disposed near the pair of discharging rollers 10, such that the free end portion 18j is located adjacent to the stacked portion 9 (see FIGS. 4A to 4E).

As illustrated in FIG. 6B, the contact flags 18b each include a first connection portion (tapered portion) 18g, which is an inclined guide surface according to this embodiment, at a lower surface. A sheet discharged from the apparatus comes in contact with the first connection portion 18g at first. The lower surface of each contact flag 18b further includes a sheet surface detection portion 18h, which is configured to detect the sheet on the stacked portion, in the free end portion 18j and a second connection portion 18i connecting the sheet surface detection portion 18h with the first connection portion 18g. In other words, the contact flag 18b includes the first connection portion 18g as the inclined guide surface inclined at an angle along the inclination of the surface Sk (FIG. 3A), which is bent in the wave form in the width direction (indicated by the arrow I in FIG. 5), of the sheet, which is bent in the wave form for stiffening and discharged by the pair of discharging rollers 10, and the second connection portion 18i.

In this embodiment, the first connection portion 18g includes the inclined guide surface (tapered portion), which corresponds to the sheet surface detection portion 18h in the contact flag 18b of the first embodiment. In this embodiment, a tangent line of the sheet surface detection portion 18h to the surface of the sheet extends linearly in substantially parallel to the discharging detection sensor unit shaft 18a. In addition, the second connection portion 18i is a connection surface smoothly connecting the first connection portion 18g with the sheet surface detection portion 18h. In other words, in the contact flag 18b of the present embodiment, the free end portion 18j comes in contact with the sheet discharged by the pair of discharging rollers 10 while the discharging detection sensor unit shaft 18a as the base portion is rotatably supported by the apparatus body 100a. In addition, the first connection portion 18g as the inclined guide surface is provided between the free end portion 18j and the discharging detection sensor unit shaft 18a.

With the above-described configuration of the present embodiment, the first connection portion 18g as the inclined guide surface prevents the contact flag 18b from having abnormal wear. In addition, since the sheet surface detection portion 18h extends substantially parallel to the discharging detection sensor unit shaft 18a, the sheet surface detection portion 18h extends linearly in a direction substantially perpendicular to the sheet delivery direction. This shortens time required for the rear end of the sheet to pass through the discharging detection sensor unit 18, and thus shortens the waiting time required for the next sheet. Thus, this configuration is applicable to an image forming apparatus 100 in which an image is formed at a higher speed.

In the first embodiment, the sheet surface detection portion 18h included in the free end portion 18j of the contact flag 18b includes the inclined guide surface. In the second embodiment, the inclined guide surface is provided between the free end portion 18j and the discharging detection sensor unit shaft 18a. However, the contact flag 18b may include both the inclined guide surface at the sheet surface detection portion 18h and the inclined guide surface at the position between the free end portion 18j and the discharging detection sensor unit shaft 18a. Such a configuration provides advantages substantially same as those described above. This configuration is applicable to third and fourth embodiments described later.

### Third Embodiment

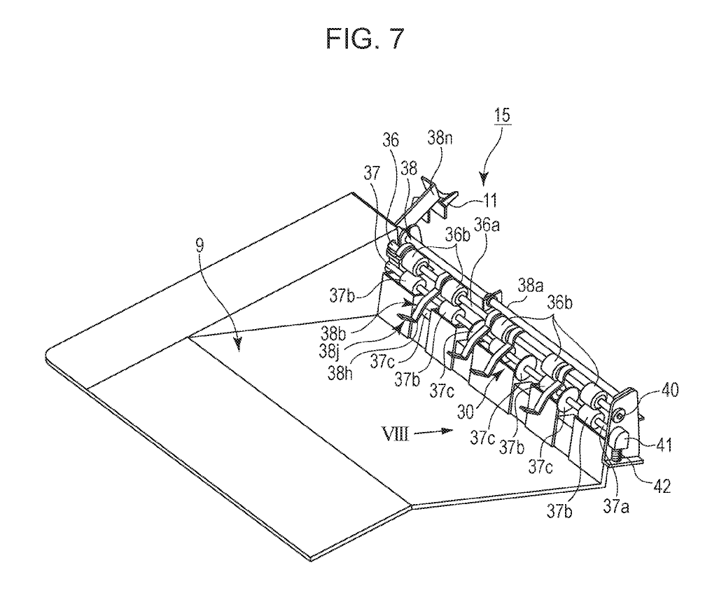

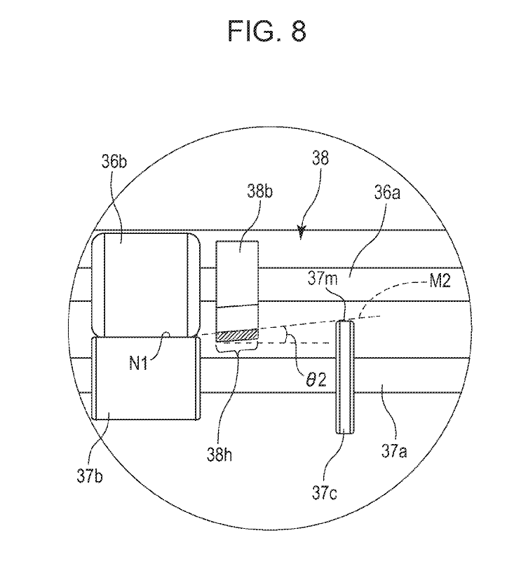

Next, a sheet discharging portion 15, which is a sheet discharging apparatus, according to a third embodiment of the present invention is described with reference to FIG. 7 and FIG. 8. FIG. 7 is a perspective view illustrating the sheet discharging portion 15 according to the present embodiment. FIG. 8 is a view of a portion of the sheet discharging portion 15 viewed in a direction indicated by the arrow VIII in FIG. 7. In this embodiment, components corresponding to those in the first embodiment are assigned the same reference numerals as those in the first embodiment, and the configurations and the functions thereof are not described if they are identical to those in the first embodiment.

In the third embodiment and a fourth embodiment, which is described later, the first and second discharging roller bodies are not arranged alternately in the comb like arrangement as in the first and second embodiments, but the first and second discharging roller bodies face each other and form a nip portion. In the third and fourth embodiments, a sheet surface detection portion 38h included in a free end portion 38j of a contact flag 38b includes the inclined guide surface. However, as in the above-described second embodiment, the inclined guide surface may be provided at the position between the free end portion 38j and a shaft (base portion) 38a.

As illustrated in FIG. 7, the sheet discharging portion 15 according to the present embodiment includes a pair of discharging rollers (discharging portion) 30 configured to discharge a sheet from the apparatus body 100a (see FIG. 1). The pair of discharging rollers 30 includes an upper discharging roller 36 and a lower discharging roller 37. The upper discharging roller 36 of the pair of discharging rollers 30 includes a first rotation shaft 36a rotatably supported by a bearing 40 disposed at its axial end and a plurality of first discharging roller bodies 36b configured to be in contact with the sheet and discharge the sheet. The lower discharging roller 37 of the pair of discharging rollers 30 includes a plurality of second discharging roller bodies 37b supported by a second rotation shaft 37a and facing corresponding one of the first discharging roller bodies 36b. The number of the second discharging roller bodies 37b is the same as the number of the first discharging roller bodies 36b. The lower discharging roller 37 is pressed against the upper discharging roller 36 by a compression spring 42 through a bearing 41 with a predetermined pressure while the second rotation shaft 37a is rotatably supported by the bearing 41.

The lower discharging roller 37 includes stiffening rollers 37c each having a larger outer diameter than the second discharging roller body 37b at positions between the second discharging roller bodies 37b. The stiffening rollers 37c positioned between the second discharging roller bodies 37b bend the sheet S sandwiched between the first and second discharging roller bodies 36b and 37b in the wave form for stiffening. In addition, a discharging detection sensor unit 38, which is configured to detect that the sheet is discharged from the apparatus by the pair of discharging roller 30, is disposed near the pair of discharging rollers 30. The sheet detected by the discharging detection sensor unit 38 and discharged from the apparatus is sequentially stacked on the sheet stacked portion 9.

The above-described pair of discharging rollers 30 includes at least one first discharging roller body 36b supported coaxially by the first rotation shaft 36a and at least one second discharging roller body 37b supported coaxially by the second rotation shaft 37a. The first discharging roller body 36b and the second discharging roller body 37b face the front surface and the rear surface of the sheet to be discharged, respectively. The first discharging roller body 36b and the second discharging roller body 37b are located at the same position in the width direction (indicated by the arrow I in FIG. 5) so as to face and be pressed against each other. In addition, the pair of discharging rollers 30 includes the stiffening rollers 37c supported by the second rotation shaft 37a so as to face a space between the adjacent first discharging roller bodies 36b. The stiffening roller 37c has a larger diameter than the second discharging roller body 37b.

The stiffening roller 37c may be positioned differently from the above-described configuration. Specifically, the stiffening roller 37c having a larger diameter than the first discharging roller body 36b may be supported by the first rotation shaft. 36a so as to face a space between the second discharging roller bodies 37b. The stiffening roller 37c disposed on the upper discharging roller 36, instead of the lower discharging roller 37, provides the same advantages as the stiffening roller 37c disposed on the lower discharging roller 37.

As illustrated in FIG. 8, the inclined guide surface of the sheet surface detection portion 38h at the position near the nip portion Ni of the pair of discharging rollers 30 has the configuration described below. The inclined guide surface 38h is inclined at an angle θ2 so as to extend along a straight line M2 connecting an end adjacent to the stiffening roller 37c of the nip portion Ni, which is provided between the opposed first and second discharging roller bodies 36b and 37b, with an outer peripheral surface 37m of the stiffening roller 37c. The nip portion Ni and the outer peripheral surface 37m are adjacent to each other in the width direction in a space between the first and second rotation shafts 36a and 37a.

In the above-described embodiment, the present invention is applicable to a discharging portion including a transportation system configured to grip the sheet firmly at the front and rear surfaces of the sheet and a stiffening roller. In other words, the sheet surface detection portion 38h inclined at the angle θ2 reduces the abnormal wear of the contact flag (contact member) 38b without using a material having high wearing resistance or using an additional high polymer sheet having low friction coefficient.

### Fourth Embodiment

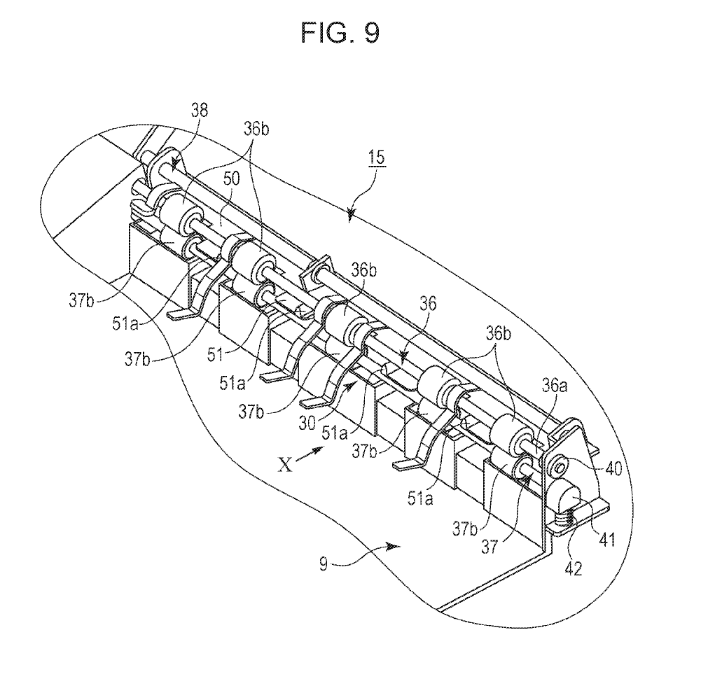

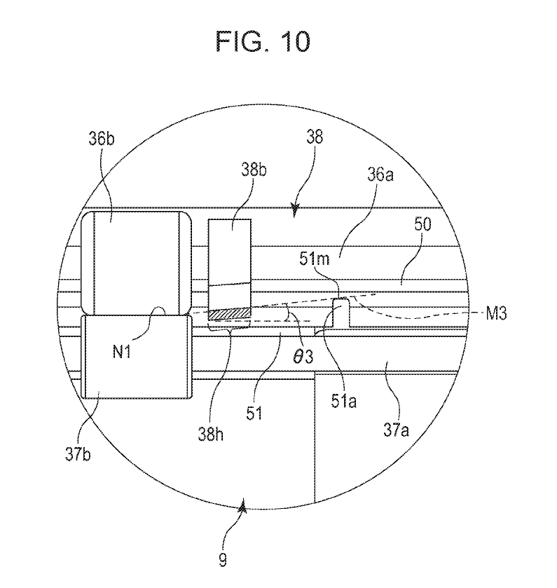

Next, a sheet discharging portion 15, which is a sheet discharging apparatus, according to a fourth embodiment of the present invention is described with reference to FIG. 9 and FIG. 10. FIG. 9 is a perspective view illustrating the sheet discharging portion 15 according to the present embodiment. FIG. 10 is a view illustrating a portion of the sheet discharging portion 15 according to the present embodiment viewed in a direction indicated by the arrow X in FIG. 9. In the present embodiment, components corresponding to those in the first embodiment are assigned the same reference numerals as those in the first embodiment, and the configurations and functions thereof are not described if they are identical to those in the first embodiment.

As illustrated in FIG. 9, the sheet discharging portion 15 according to the present embodiment includes a pair of discharging rollers (discharging portion) 30 configured to discharge the sheet from the apparatus body 100a (see FIG. 1). The pair of discharging rollers 30 includes an upper discharging roller 36 and a lower discharging roller 37. The upper discharging roller 36 of the pair of discharging rollers 30 includes a first rotation shaft 36a rotatably supported, by a bearing 40 disposed at its axial end and a plurality of first discharging roller bodies 36b configured to be in contact with the sheet and discharge the sheet. The lower discharging roller 37 of the pair of discharging rollers 30 includes a plurality of second discharging roller bodies 37b supported by a second rotation shaft 37a (FIG. 10) and facing corresponding one of the first discharging roller bodies 36b. The number of the second discharging roller bodies 37b is the same as the number of the first discharging roller bodies 36b. The lower discharging roller 37 is pressed against the upper discharging roller 36 with a predetermined pressure by a compression spring 42 through a bearing 41 while the second rotation shaft 37a is rotatably supported by the bearing 41.

In the lower discharging roller 37, stiffening ribs (stiffening protrusions) 51a each protruding beyond an outer peripheral surface of the second discharging roller body 37b are disposed between the second discharging roller bodies 37b. The stiffening ribs 51a between the second discharging roller bodies 37b bend the sheet S, which is sandwiched between the first and second discharging roller bodies 36b and 37b, in the wave form for stiffening. In addition, a discharging detection sensor unit 38, which is configured to detect that the sheet is discharged from the apparatus by the pair of discharging rollers 30, is disposed near the pair of discharging rollers 30. The sheet detected by the discharging detection sensor unit 38 and discharged from the apparatus is sequentially stacked on a sheet stacked portion 9.

The above-described pair of discharging rollers 30 includes at least one first discharging roller body 36b supported coaxially by the first rotation shaft 36a and at least one second discharging roller body 37b supported coaxially by the second rotation shaft 37a. The first discharging roller body 36b and the second discharging roller body 37b face the front surface and the rear surface of the sheet to be discharged, respectively. The first discharging roller body 36b and the second discharging roller body 37b are located at the same position in the width direction (indicated by the arrow I in FIG. 5) so as to face and be pressed against each other. The pair of discharging rollers 30 further includes the stiffening rib (stiffening protrusion) 51a supported by the second rotation shaft 37a so as to face a space between the adjacent first discharging roller bodies 36b. The stiffening rib 51a protrudes beyond the outer peripheral surface of the second discharging roller body 37b.

The stiffening rib 51a may be positioned differently from the above-described configuration. Specifically, the stiffening rib 51a protruding beyond the outer peripheral surface of the first discharging roller body 36b may be supported by the first rotation shaft 36a so as to face a space between the adjacent second discharging roller bodies 37b. In this embodiment, the stiffening rib 51a is disposed on a lower discharging guide 51, but the position of the stiffening rib 51a is not limited thereto. The stiffening rib 51a may be disposed on an upper discharging guide 50. As described above, the stiffening rib 51a disposed on the upper discharging roller 36, instead of the lower discharging roller 37, provides the same advantages as those described above.

As illustrated in FIG. 10, the inclined guide surface on the sheet surface detection portion 38h near the nip portion Ni of the pair of discharging rollers 30 has the configuration described below. The inclined guide surface is inclined at an angle θ3 so as to extend along a straight line M3 connecting an end adjacent to the stiffening rib 51a of the nip portion Ni, which is provided between the opposed first and second discharging roller bodies 36b and 37b, with a front surface 51m of the stiffening rib 51a. The nip portion Ni and the stiffening rib 51a are adjacent to each other in the width direction in a space between the first and second rotation shafts 36a and 37a.

In the above-described embodiment, the present invention is applicable to a discharging portion including a transportation system configured to grip the sheet firmly at the front and rear surfaces of the sheet and a stiffening rib. In other words, the sheet surface detection portion 38h inclined at the angle θ3 reduces the abnormal wear of the contact flag (contact member) 38b without using a material having high wearing resistance or using an additional high polymer sheet having low friction coefficient.

In this embodiment, the stiffening rib 51a is used as a stiffening protrusion, but the shape of the stiffening protrusion is not limited. The stiffening protrusion may have any protruded shape inclined along the inclined guide surface, which is positioned near the nip portion Ni of the pair of discharging rollers 30, and the straight line M3 so as to bend the sheet. In addition, a stiffening member may be provided as a separate member. The stiffening member may be configured to be retracted by contact of a sheet having high strength.

In this embodiment, the image forming apparatus 100 using an electrophotography process is described. However, the present embodiment may be applied to an image forming apparatus using an inkjet process in which ink droplets are discharged from nozzles to form an image on a sheet, for example, instead of the image forming apparatus 100 using an electrophotography process.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-206278, filed Oct. 20, 2015, which is hereby incorporated by reference herein in its entirety.

What is claimed is:

1. A sheet discharging apparatus configured to discharge a sheet, the sheet discharging apparatus comprising:
a discharging portion configured to discharge a sheet so as to be bent in a curved shape in a width direction of the sheet perpendicular to a discharging direction of the sheet when viewed in a sheet discharging direction;
a contact member configured to be moved by contact with the sheet discharged by the discharging portion, wherein the contact member includes a contact surface to be in contact with the sheet which is inclined along the curved shape of the sheet in the width direction of the sheet when viewed in the sheet discharging direction; and
a detector configured to detect a discharging of the sheet based on the movement of the contact member.

2. The sheet discharging apparatus according to claim 1, further comprising a stacked portion on which the sheet discharged by the discharging portion is stacked,
wherein the detector is configured to detect, based on the movement of the contact member, that sheets on the stacked portion reach a stack limit.

3. The sheet discharging apparatus according to claim 1,
wherein the discharging portion includes a first discharging roller and a second discharging roller, wherein the second discharging roller is located on an opposite side of the sheet discharged by the discharging portion from the first discharging roller and located at a position different from the first discharging roller in an axial direction of the first discharging roller, when the discharging portion is viewed in the sheet discharging direction, and
wherein an outer peripheral portion of the first discharging roller and an outer peripheral portion of the second discharging roller overlap with each other in a direction perpendicular to both the sheet discharging direction in the discharging portion and the width direction of the sheet.

4. The sheet discharging apparatus according to claim 3, wherein the contact member is provided between the first discharging roller and the second discharging roller in the width direction of the sheet.

5. A method for a sheet discharging apparatus configured to discharge a sheet, the method comprising:
discharging, via a discharging portion, a sheet so as to be bent in a curved shape in a width direction of the sheet, perpendicular to a discharging direction of the sheet when viewed in a sheet discharging direction;
moving a contact member by contact with the sheet discharged by the discharging portion, wherein the contact member includes a contact surface to be in contact with the sheet which is inclined along the curved shape of the sheet in the width direction of the sheet when viewed in the sheet discharging direction; and
detecting a discharging of the sheet based on the movement of the contact member.
